(19) United States
(12) Patent Application Publication
(10) Pub. No.: US 2006/0150814 A1
(43) Pub. Date: Jul. 13, 2006

(54) Method and plant for the purification of produced water

(75) Inventors: Hans Goksoyr, NESOYA (NO); Norolf Henriksen, Notodden (NO)

Correspondence Address: WENDEROTH, LIND & PONACK, L.L.P., 2033 K STREET N. W., SUITE 800, WASHINGTON, DC, 20006-1021, US

(73) Assignee: MINOX TECHNOLOGY AS, NOTODDEN (NO)

(21) Appl. No.: 10/545,104

(22) PCT Filed: Feb. 4, 2004
(86) PCT No.: PCT/NO04/00034

§ 371 Date: Nov. 9, 2005

(30) Foreign Application Priority Data
Feb. 10, 2003 (NO) 20030647

(51) Int. Cl. B01D 19/00

(52) U.S. Cl. 95/263

(57) ABSTRACT

A method and a system for removing dispersed and dissolved hydrocarbons from produced water in connection with the extraction of oil and gas from geological formations beneath the sea bed or the ground. The produced water first undergoes mechanical or electromechanical treatment in a sub-process “A” to remove the dispersed hydrocarbons from the water and is subsequently treated in a sub-process “B” by stripping with a circulating inert gas in one or more stages (1, 2) to remove the dissolved hydrocarbons. The inert gas consists expediently of N2 containing 02 and the subsequent removal of the hydrocarbons is carried out in a catalytic converter (5) by catalytic combustion of the stripped hydrocarbons.

The present invention concerns a method and a system for removing dissolved hydrocarbons (HC) from produced water in connection with the extraction of oil and gas.

During the production of oil and gas from geological formations beneath the sea bed and the ground, considerable quantities of water are also produced. In professional circles this is called “produced water”. Apart from dispersed oil, this water also contains various types of dissolved hydrocarbon (HC) in addition to dissolved metals and other chemical substances. Some types of the dissolved HC can be stripped out of the water while others can only be removed by adsorption in special types of filter material. Produced water is generally dumped, i.e., in connection with offshore production of oil and gas, discharged into the sea.

Regarding the content of dispersed oil in dumped water, the authorities in the various countries have set discharge requirements that must be met by the oil companies that extract oil and gas. In the Norwegian sector of the North Sea and the Norwegian Sea, this requirement is currently 40 ppm oil for produced water. However, there are not currently any specific discharge requirements for dissolved hydrocarbons (HC). Typical HC of this type are benzene, toluene and xylene (BTX).

The reason for this is that no general process has yet been developed that the authorities can recommend on the basis of a technical/financial assessment. The result is that large quantities of produced water are currently dumped with a relatively low content of dissolved HC in relation to the quantity of dispersed oil. However, the dissolved hydrocarbons have considerably higher toxicity in some cases.

Extensive development work has been done to develop processes that can be used to remove dissolved HC. One process, the Cetour process, is based on using an HC condensate that is injected in produced water in a hydrocyclone and is distributed effectively in the water. The condensate is intended primarily to absorb dispersed oil, which is subsequently removed from the water in a separator. However, the possibility of removing dissolved HC was obviously also an aim.

One negative effect of this process, however, is that, if the condensate contains dissolved HC, for example BTX, these HC will be dissolved in the water. In order for the Cetour process to work optimally, a very pure condensate is therefore required, which may often be hard to obtain in some oil fields. The assumed conclusion is that dissolved HC, in general, cannot be removed by this process, and the Cetour process alone cannot, therefore, as far as can be ascertained, be used for total purification of produced water.

The present invention represents a process that, combined with other prior art processes for removal of dispersed oil, will also remove dispersed HC, for example BTX. Water that is virtually free of dispersed oil is passed through a system in which dissolved hydrocarbons are stripped out of the water using an inert gas with small quantities of oxygen added. After having been heated to a relatively high temperature, the gas is subsequently passed through a catalytic converter, preferably a precious metal catalytic converter, in which the stripped HC burn catalytically with oxygen from the stripping gas. The combustion products are water vapour and CO₂.

In order to supply the necessary oxygen to the stripping system, there is a constant bleed of gas (mainly N₂) out of the system downstream of the catalytic converter and a corresponding inflow of make-up air into the system. The majority of the CO₂ from the catalytic combustion is absorbed by the water and passed out of the system in that way.

The present invention is characterised by a method as defined in the attached independent claim 1 and a system as defined in the attached independent claim 6. Dependent claims 2-5 and 7-14 define advantageous embodiments of the present invention. The theoretical degree of strippability for the various components can be indicated by their so-called Henry's constant, “H”, which indicates the ratio at equilibrium between the concentration of the hydrocarbon component in the atmosphere (the stripping gas) and the concentration of the component in the aqueous phase.

The literature gives the following figures for H for the most relevant substances to be stripped out, benzene, toluene and xylene (the BTX group), mg/l gas per mg/l water at 25° C.:
Benzene 0.25
Toluene 0.30
Xylene 0.24

In tests in a small test system, very good conformity was found between the results achieved and the results expected, based on the relevant Henry's constants. As the individual types of HC in the BTX group have virtually equal H values, it was decided just to use benzene during tests in a large system (see later tests).

Theoretically, air can be used as the stripping gas, but for safety reasons it is desirable for the stripping gas to have a low oxygen content, for example 1-2%. The preferred stripping gas is N₂, which is easy to “produce” directly in the system. Therefore, N₂ with 1-2% O₂ was used in the further tests with the present invention.

The present invention will be described in further detail in the following using examples and with reference to the attached drawings, where:

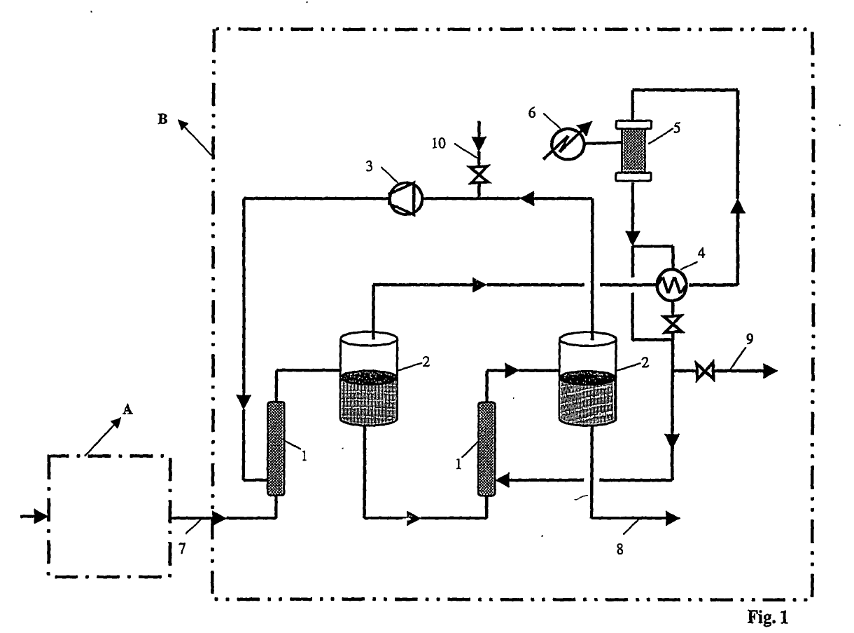

FIG. 1 shows a simple flow diagram for the method and system in accordance with the present invention.

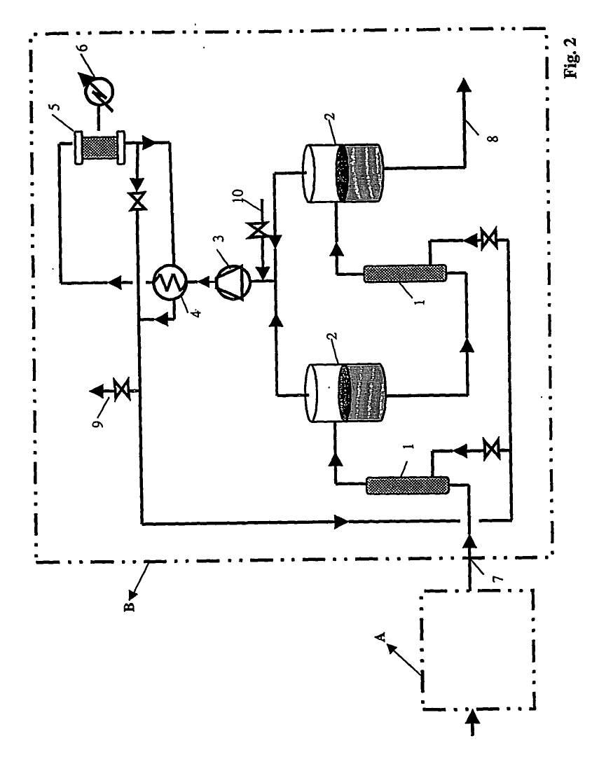

FIG. 2 shows an alternative embodiment of the same system.

The method and the system in accordance with the present invention are based on the produced water undergoing a sub-process “A” before the stripping process. In this sub-process, dispersed oil is removed from the water fully or partially in a prior art manner, for example using a conventional flocculation-flotation method, which will not be described here. The water is subsequently treated in a stripping system with catalytic combustion of the stripped HC, as defined in the present claims.

FIG. 1 and FIG. 2 show, as stated above, the solution in principle for the method and the system in accordance with the present invention. Preferably, virtually all of the dispersed oil should be removed from the production water before stripping. The method used for this is of virtually no importance to the subsequent stripping process. Alternatively, chemicals can also be added in connection with the separation process to improve the separation of the hydrocarbons (oil particles) in connection with their flocculation. The separation process for oil can mainly otherwise be based on prior art equipment and chemicals and will not be described here.

In the example shown in the figures, the second process part “B” constitutes a 2-stage process in which the mass transfer units (stripping units) consist of vertical static mixers 1. The present invention as it is defined in the claims is not, however, limited to this type of mixer. It may, for example, consist of vertical pipe loop or dynamic mixers. With two stages as shown here, 90-95% of the dissolved quantity of HC can be stripped out.

Produced water, which is purified in process part “A” so that dispersed oil is removed, arrives in the pipe 7 and is passed to the first stage, i.e. the first static mixer 1 in process part “B”. Gas is supplied in the mixer 1 and is mixed with the water, which is passed on to a liquid/gas separator 2. From the liquid/gas separator 2, the water is passed on to a second stage, i.e. another static mixer 1, and from there to another gas/liquid separator 2. The stripping gas can either, as shown in FIG. 1, be passed from the gas/liquid separator via a compressor or blower 3 against the flow of the water over the 2 stages, or the gas can, as shown in FIG. 2, be distributed in two separate channels to the static mixers 1 and subsequently be passed together via the compressor/blower 3 and the heat exchanger 4 and on through a catalytic converter 5. The preferred stripping gas is N₂, as stated above, but a certain amount of O₂ must be present in the stripping gas when it is passed into the catalytic converter for combustion of the hydrocarbons.

The oxygen level is maintained by means of a controlled bleed of the stripping gas via an outlet pipe 9 from the system, downstream of the catalytic converter 5, while a corresponding amount of air (O₂) is passed in via an inlet pipe 10 upstream of the catalytic converter 5.

Various types of precious metal catalytic converter can be used expediently for combustion. In the tests carried out with the present invention, palladium was used, applied to a core material of SiO₂ in granulate form.

The combustion temperature for various types of hydrocarbon is in the range of 250-400° C. However, it is expedient for the catalytic converter to be designed for combustion temperatures up to 750° C.

In the tests carried out mentioned below, the stripping gas was preheated with the hydrocarbons to the relevant reaction temperature in an electric preheater 6. In a technical system, it is necessary for such a preheater to be used during system startup. As the reaction between the hydrocarbons and oxygen is highly exothermic, the temperature in the catalytic converter will be maintained during normal operation by means of the heat exchanger 4 for inflow/outflow gas in connection with the catalytic converter chamber 5.

Tests

Tests were carried out in two periods with two different systems equivalent to the system shown in FIG. 1 but with just one stage. The first system had a capacity of approximately 200 l/h water, while the second system had a capacity of up to 500 l/h. In the first few tests, freshwater was used, while, in the other tests, seawater was used that had been preheated to 50-70° C. This temperature is regarded as being representative for produced water. N₂ from a bottle battery (virtually CO₂-free) was used as the stripping gas. Air (O₂) was added ahead of the catalytic converter 5 so that the gas had an O₂ content of 1-2%. Initially, the dissolved hydrocarbons used in the tests were hydrocarbons from the entire BTX group but it was gradually found that benzene was representative of both the BIX group as a whole and naphthalene. Therefore, for the remaining tests, just benzene was used.

In addition to benzene, the water in the tests in the last period also contained dispersed hydrocarbons equivalent to approximately 1000 ppm.

The test analyses were based on the measured quantity of HC in treated and untreated water. However, CO₂ measurements in the gas were also carried out. In the first system, the hydrocarbons were mixed into the water tank before the test. In the tests in the large system, a concentrate of dissolved benzene was metered into the water supply.

All the results from water samples showed that the reduction in dissolved hydrocarbons in treated water was well over 80%. As stated above, this was achieved in a one-stage system. In a two-stage system, the reduction would theoretically be over 96% and in practice at least over 90%.

The tests also showed that the dispersed hydrocarbons had no effect on the stripping process or its effectiveness.

1. A method for removing dissolved hydrocarbons from produced water in connection with the extraction of oil and gas from geological formations beneath the sea bed or the ground, where dispersed hydrocarbons have been removed from the water in a preceding process, based on mechanical, electromechanical or chemical treatment,
characterised in that dissolved hydrocarbons, for example BTX, are removed from the water by stripping with a circulating inert gas containing oxygen in a one-stage or multi-stage co-current stripping system and that the gas is subsequently, after the necessary preheating to reaction temperature, passed through a catalytic converter (5) in which stripped hydrocarbons are burned with oxygen from the stripping gas.

2. A method in accordance with claim 1,
characterised in that a precious metal catalytic converter is used as the catalytic converter (5).

3. A method in accordance with claim 1,
characterised in that the ratio of circulating gas measured in normal cubic metres to the volume of treated water in each stripping stage is between 2:1 and 20:1.

4. A method in accordance with claims 1 and 3,
characterised in that the dissolved hydrocarbons are stripped from the water in one or more stages (1, 2) in a system designed as vertical pipe elements with or without integrated static mixer elements.

5. A method in accordance with claims 1, 3 and 4,
characterised in that the inert gas is N₂.

6. A system for removing dissolved hydrocarbons from produced water in connection with the extraction of oil and gas from geological formations beneath the sea bed or the ground, where dispersed hydrocarbons have been removed from the water in a preceding process (A), based on mechanical, electromechanical or chemical treatment,
characterised in that dissolved hydrocarbons, for example BTX, are removed from the water by stripping with a circulating inert gas containing oxygen in a one-stage or multi-stage co-current stripping system or sub-process (B), comprising stripping equipment (1, 2) to strip the produced water, and that the gas is subsequently, after the necessary preheating to reaction temperature, designed to be passed through a catalytic converter (5) in which stripped hydrocarbons are burned with oxygen from the stripping gas.

7. A system in accordance with claim 6,
characterised in that the equipment in the stripping system “B” comprises one or more stripping stages (1, 2) or mass transfer units consisting of vertical static mixers (1), a vertical pipe loop or dynamic mixers.

8. A system in accordance with claim 7,
characterised in that the stripping gas is added to the production water co-currently in the mixer (1).

9. A system in accordance with claim 6,
characterised in that the stripping gas consists of N₂ containing O₂, and the subsequent removal of the hydrocarbons is carried out in a precious metal catalytic converter (5) by catalytic combustion of the stripped hydrocarbons.

10. A system in accordance with claim 7,
characterised in that the mixer (1) for each stage is connected to a subsequent gas/liquid separator (2).

11. A system in accordance with claim 10,
characterised in that the gas is passed from the liquid/gas separator (2) to a blower (3) via a heat exchanger (4) to the catalytic converter (5), and the combustion gas is passed to the mixers (1) after removal of any surplus gas (at 9).

12. A system in accordance with claim 11,
characterised in that the combustion gas from the catalytic converter (5) is passed in a loop to the heat exchanger (4) for heat exchange with the gas from the separator(s) (2).

13. A system in accordance with claim 10,
characterised in that the gas from the separator (2) in the last stage in sub-process “B” is passed via a blower (3, FIG. 1) to the mixer (1) in the first stage, while the gas from the gas/liquid separator in the first stage is passed via a heat exchanger (4) to the catalytic converter (5), and the combustion gas from the catalytic converter (5) is passed to the mixer (1) in the last stage.

14. A system in accordance with claim 6,
characterised in that the separated water is passed from the separator(s) (2) to the next stage (1, 2) in the sub-process or to the environment.

15. A method in accordance with claim 3,
characterised in that the dissolved hydrocarbons are stripped from the water in one or more stages (1, 2) in a system designed as vertical pipe elements with or without integrated static mixer elements.

16. A method in accordance with claim 3,
characterised in that the inert gas is N₂.

17. A method in accordance with claim 4,
characterised in that the inert gas is N₂.

18. A system in accordance with claim 7,
characterised in that the stripping gas consists of N₂ containing O₂, and the subsequent removal of the hydrocarbons is carried out in a precious metal catalytic converter (5) by catalytic combustion of the stripped hydrocarbons.

19. A system in accordance with claim 8,
characterised in that the stripping gas consists of N₂ containing O₂, and the subsequent removal of the hydrocarbons is carried out in a precious metal catalytic converter (5) by catalytic combustion of the stripped hydrocarbons.

20. A system in accordance with claim 8,
characterised in that the mixer (1) for each stage is connected to a subsequent gas/liquid separator (2).

21. A system in accordance with claim 9,
characterised in that the mixer (1) for each stage is connected to a subsequent gas/liquid separator (2).
